(19) United States
(12) Patent Application Publication
(10) Pub. No.: US 2025/0200575 A1
(43) Pub. Date: Jun. 19, 2025

(54) System for Authentication, Real-Time Communication, and Payments in Networked Gaming Machines

(71) Applicant: Turner Logic, LLC, Boerne, TX (US)

(72) Inventor: Christopher Turner, Boerne, TX (US)

(21) Appl. No.: 19/066,646

(22) Filed: Feb. 28, 2025

Related U.S. Application Data
(63) Continuation of application No. 18/920,718, filed on Oct. 18, 2024.
(60) Provisional application No. 63/591,440, filed on Oct. 18, 2023.

(51) Int. Cl. G06Q 20/40

(52) U.S. Cl. CPC G06Q 20/401

(57) ABSTRACT

The present invention provides a system for secure authentication, real-time communication, and payment processing in networked gaming machines, including pinball and arcade systems. The system comprises a service provider server, a downloadable application for users and machine owners, and a gaming machine equipped with a display screen, internet connectivity, and unique identification. Secure communication between the gaming machine and the server is facilitated using cryptographic techniques, including HMAC-based message authentication and public/private key encryption. The system supports real-time gameplay data transmission, user interactions, and secure electronic payments via QR codes. Real-time interaction is enabled through WebSocket connections, allowing dynamic player actions, such as score tracking and multi-user engagement. Additionally, a retrofit kit is available for upgrading legacy machines to support secure payments and real-time communication. The system further includes features for service mode operations, tournament management, and social interactions, providing a modernized, fully connected gaming experience.

### CROSS-REFERENCES TO RELATED APPLICATIONS

This application claims the benefit of U.S. Provisional Application Ser. No. 63/591,440, filed Oct. 18, 2023 entitled Authentication and Network System for Gaming Machines and is continuation of U.S. Non-Provisional application Ser. No. 18/920,718, filed Oct. 18, 2024, entitled System for Authentication, Real-Time Communication, and Payments in Networked Gaming Machines, both of which are incorporated by reference herein.

### STATEMENT REGARDING FEDERALLY SPONSORED RESEARCH OR DEVELOPMENT

Not applicable.

### BACKGROUND OF THE INVENTION

### 1. Field of the Invention

The present invention relates to a system for secure authentication, real-time communication, and payment processing in gaming systems. More specifically, it involves internet-connected machines (such as pinball and arcade games), providing features such as secure game session management, player interaction, and remote machine administration via mobile applications.

### 2. Background of Related Art

Current arcade and pinball gaming systems typically rely on physical payment mechanisms, such as coin-operated or token-based systems, to facilitate user interactions with the machine. Many legacy systems lack modern internet connectivity, secure electronic payment options, or advanced real-time communication capabilities. In cases where internet connectivity does exist, it is often limited to simple data retrieval or score submission without full integration for real-time interactions or user-specific authentication. In the case where a more modern credit card reader or scanning device is used for payment, it requires additional hardware to be purchased and installed into the gaming machine.

Authentication methods in gaming systems have traditionally relied on physical keys or tokens, especially for service or administrative modes. These approaches, while effective for local control, do not offer the scalability or security needed for internet-connected devices that must support a wide range of user actions, including remote monitoring, real-time game management, and electronic payments. Additionally, newer forms of electronic authentication require additional physical hardware to be present on the machine to perform functions like reading an RFID card, reading a magnetic stripe card, scanning a fingerprint, or scanning a QR code.

Moreover, systems that do enable electronic payments often utilize external hardware like credit card readers or mobile wallets, but they are not typically integrated with the game software itself. These solutions generally lack real-time interaction between user devices (such as mobile applications) and the gaming machine, limiting user engagement during gameplay, and preventing dynamic features such as live score tracking or game control via mobile devices.

In recent years, advances in secure communication protocols, including WebSocket connections and HMAC authentication, have been applied in various fields, but these technologies have not been widely adopted in arcade and pinball machines for managing secure communications between a gaming machine and server, or for establishing player-specific sessions that involve real-time data exchange. Similarly, while QR code-based authentication has gained popularity in other sectors such as mobile payments, it has not been extensively utilized in the gaming industry for session-based authentication or gameplay interaction.

### SUMMARY OF THE INVENTION

The present invention describes a comprehensive system that overcomes the limitations of traditional arcade and pinball gaming systems by integrating advanced network connectivity, secure authentication, and real-time communication. The system comprises a service provider server, a downloadable application for owners and users, and an internet-connected machine (such as a pinball or arcade game) equipped with a display screen and a computing device. This system allows for full internet integration, enabling real-time data transmission and control between the machine, users, and the service provider server.

Authentication is facilitated using modern cryptographic techniques, such as HMAC-based message authentication, public/private key pairs, and SSL certificates, eliminating the need for traditional physical authentication hardware like keys, cards, QR code scanners, or fingerprint scanners. This ensures secure, scalable communication between machines and the server, suitable for a wide range of user actions, including remote monitoring, game management, and secure electronic payments using QR codes, all without requiring additional hardware.

The system allows machine owners to manage their machines remotely, track detailed game data, and process payments securely through the service provider server. Players can create accounts, store payment methods, and interact with the machine via a mobile application that enables real-time features such as live score tracking, player-to-player interaction, and game control. This real-time engagement is achieved using WebSocket connections, allowing dynamic gameplay enhancements, such as remote actions or sabotage in multi-user games, which were not possible in previous systems.

Service mode operations are supported for machine maintenance, with options for both internet and Bluetooth connectivity. The system may also include social features, tournament organization, and integration with other devices or services, providing a fully modernized and connected gaming experience.

Additionally, the system provides a retrofit kit for older machines not originally designed with these capabilities, allowing them to support secure payments and real-time communication.

### BRIEF SUMMARY OF THE DRAWINGS

FIG. 1 is a high-level system components overview.

FIG. 2 is an overview of the retrofit system.

FIG. 3 depicts the gaming machine authentication workflow.

FIG. 4 depicts the user/owner application authentication workflow.

FIG. 5 depicts the machine session creation and machine session channel workflow.

FIG. 6 depicts the QR scanning workflow.

FIG. 7 depicts the player session creation and player session channel workflow.

FIG. 8 is an overview of the real time communication pathways in the system.

FIG. 9 is the display screen of the gaming machine displaying a login QR code.

FIG. 10 is the dashboard of the user application and shows the scan button.

FIG. 11 is the QR scan view of the user application.

FIG. 12 is the payment view of the user application.

FIG. 13 is the live data view of the user application.

FIG. 14 is the menu/action button view of the user application.

FIG. 15 is the observer player interaction view of the user application.

FIG. 16 is the service mode view on the display screen of the gaming machine.

FIG. 17 is the service mode menu within the user/owner application.

FIG. 18 is a table of information contained in database of the service provider server.

### DETAILED DESCRIPTION OF THE INVENTION

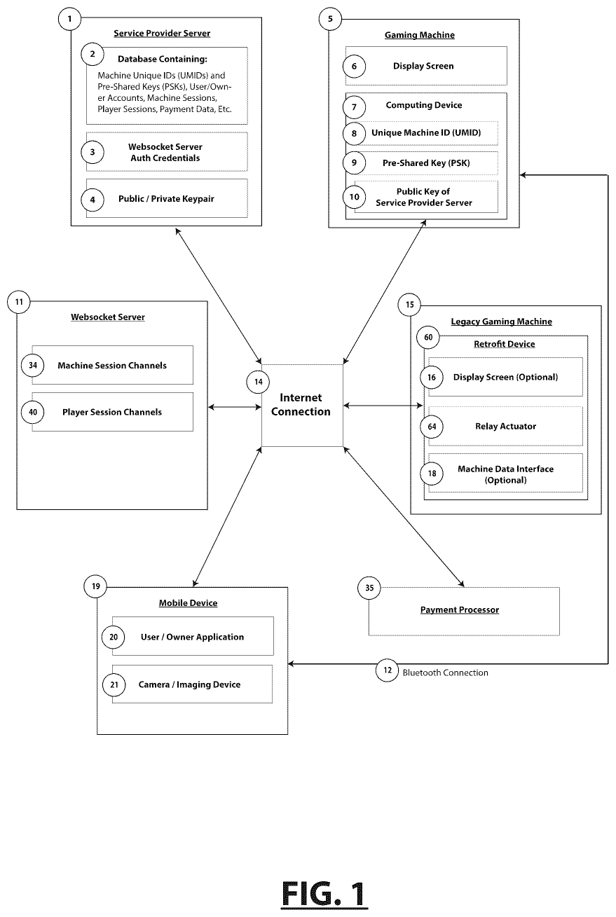

As seen in FIG. 1, the described system comprises a service provider server [1], a downloadable mobile application for owners and users [20], and a gaming machine [5] having a display screen [6] and a computing device [7] capable of connection to the internet [14] (the “System”). In the described embodiment, the machine is a physical pinball game; however the System described herein, can be used with any number of gaming systems, especially arcade style games. The System may also include a websocket server [11] or any other real-time communication methodology. The websocket server [11] is a web server that handles websocket creation and messaging services, and may be coupled with or separate from the service provider server [1].

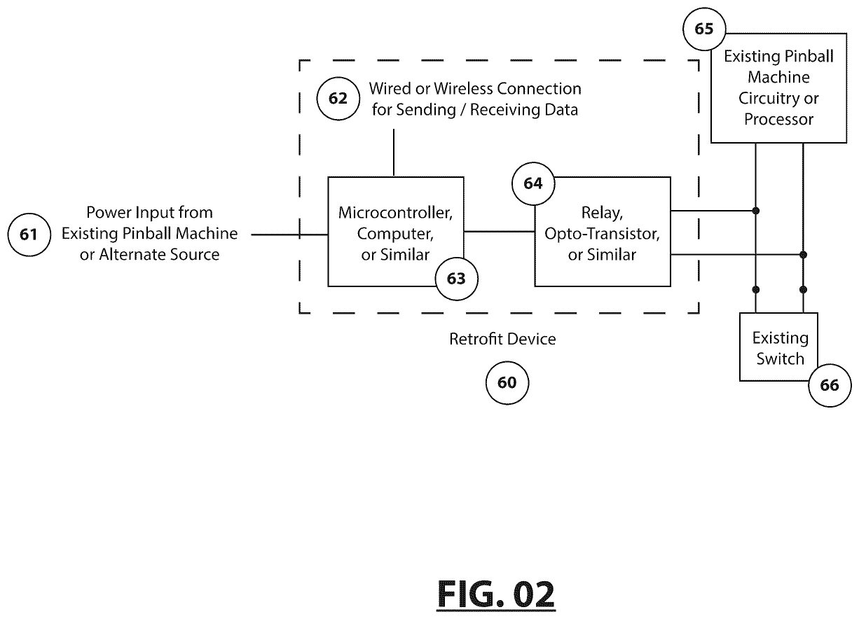

The service provider server [1] is a web server connected to the internet [14]. It holds a database [2] containing information related to users and machines and is able to perform authentication, receive data, and respond to data requests, in addition to other general web server functions. The service provider server [1] is equipped with its own public/private keypair [4], which is used for encrypting and signing data as necessary. As seen in FIG. 2, communication to and from the service provider server [1] happens via HTTPS requests, which secure the communications using standard web SSL certificates. Additionally, the service provider server [1] is equipped with websocket server authentication credentials [3] which allow the service provider server [1] to authenticate private websocket channels.

As seen in FIG. 1, each gaming machine [5] is equipped with a display screen [6], a computing device [7] capable of internet connectivity, a unique machine identifier (“UMID”) [8], and a unique pre-shared key (“PSK”) [9], the public key of the service provider server [10], as well as other identifying data. The UMID [8] and PSK [9] are securely stored within the service provider server's database [2] during the gaming machine's initial configuration. The PSK [9], known only to the gaming machine [5] and the service provider server [1], is used to generate a hash-based message authentication code (“HMAC”) for requests made from the gaming machine [5] to the service provider server [1].

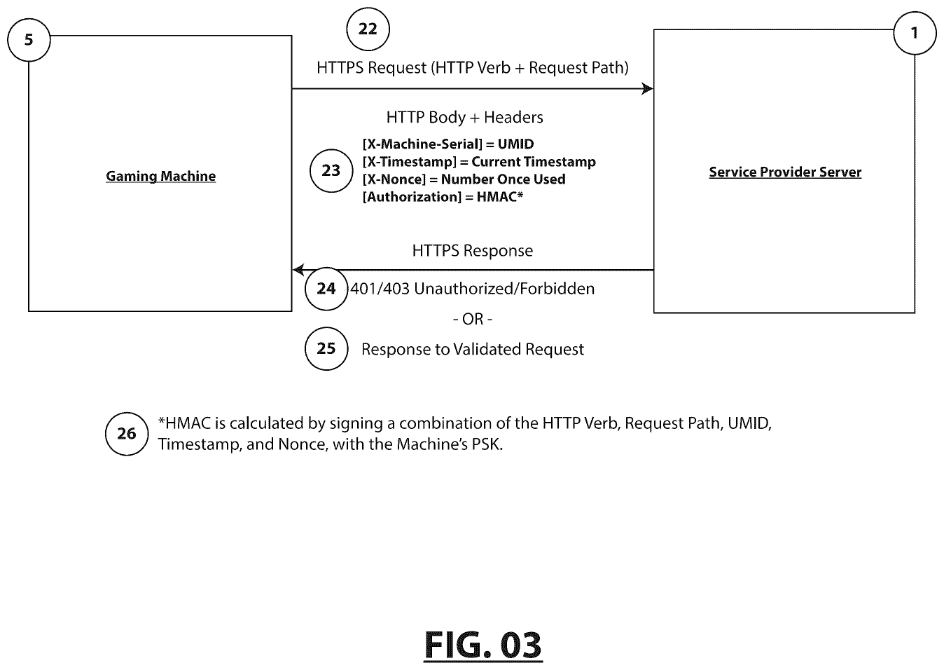

As seen in FIG. 3, when the gaming machine [5] sends a request [22] to the service provider server [1], it computes an HMAC [26] using the PSK [9] and the request payload [23]. This HMAC is included with the request [22], allowing the service provider server [1] to verify the request's authenticity. Upon receiving the request [22], the server recalculates the HMAC using the same PSK. It locates the proper PSK in its database [2] by using the UMID specified in the request's payload [23]. If the computed HMAC matches the one sent by the gaming machine [5], and since only the gaming machine [5] and service provider server [1] have knowledge of the PSK [9], the request [22] is considered valid and uncompromised [25]. If the computed HMAC does not match, the request [22] is rejected by the service provider server [1], ensuring that no tampered or unauthorized requests [24] are processed. This HMAC-based authentication ensures secure communication between the gaming machine [5] and the service provider server [1], preventing unauthorized access or request forgery, and it doesn't require a typical username/password authentication flow, which would not be suitable for the gaming machine [5]. In addition to HMAC, communication can also be authenticated using certificates, public/private key pairs, stored credentials, or other secure methods as necessary. All communication between the gaming machine [5] and the service provider server [1] is performed over an internet connection using HTTPS.

Additional data can be added to the message payload [23] sent by the machine to the service provider server [1] such as a nonce (number once used) and a timestamp, which will provide additional security. The nonce is a unique number generated for each request [22]. The timestamp reflects the current time on the gaming machine [5], kept accurate through its online connectivity. The nonce and timestamp should be included in the HMAC so that they cannot be tampered with. When the service provider server [1] receives the request [22] from the gaming machine [5], and when the HMAC for the message is validated, additional checks can be performed on the nonce and the timestamp. The nonce should be checked to make sure that it hasn't been used before to make sure that the same request [22] is not processed twice. The timestamp should be checked to make sure that it is current (within a reasonable time threshold, such as 1-10 minutes). These measures further enhance the security of communication by ensuring that each request [22] is unique and timely, protecting against replay attacks.

The System further provides mobile applications for users (“User Application”) [20] and/or owners (“Owner Application”) [20] for use on mobile devices [19] such as smartphones or tablets. Both the User Application and the Owner Application [20] communicate with the service provider server [1] for features such as account creation and authentication. The User Application and Owner Application [20] may be separate or combined together in the same downloadable application.

A gaming machine [5] owner may use the Owner Application [20] to register the gaming machine [5]. The owner may submit information related to the name of the their establishment, whether the gaming machine [5] is for personal or commercial use, the physical location of the gaming machine [5] and/or establishment, the cost to play, identification of other authorized managers of the gaming machine [5], financial account details to receive payments, and any other information an owner of a gaming machine [5] may need to facilitate ownership of the gaming machine [5]. The information provided upon registration is stored in the database [2] of the service provider server [1] and automatically links the owner data to gaming machine [5] data.

A user may use the User Application [20] to create an account which can be used for playing games on gaming machines [5]. During account creation, at a minimum, the user must supply some basic identifying information and login credentials. Payment information can optionally be provided for use on gaming machines [5] that require payment. Other user information may be requested including gamertag, avatar/picture, bio, skill level, etc. A user may also be the owner of the gaming machine. In that case, a single account can perform both the user and owner functions. The registration information and some functionality (loading payment information, checking user statistics, etc.) may be accessed by a user or owner with the service provider server [1] via HTTPS on their web browser through a standard web interface in addition to on the User and/or Owner Applications [20].

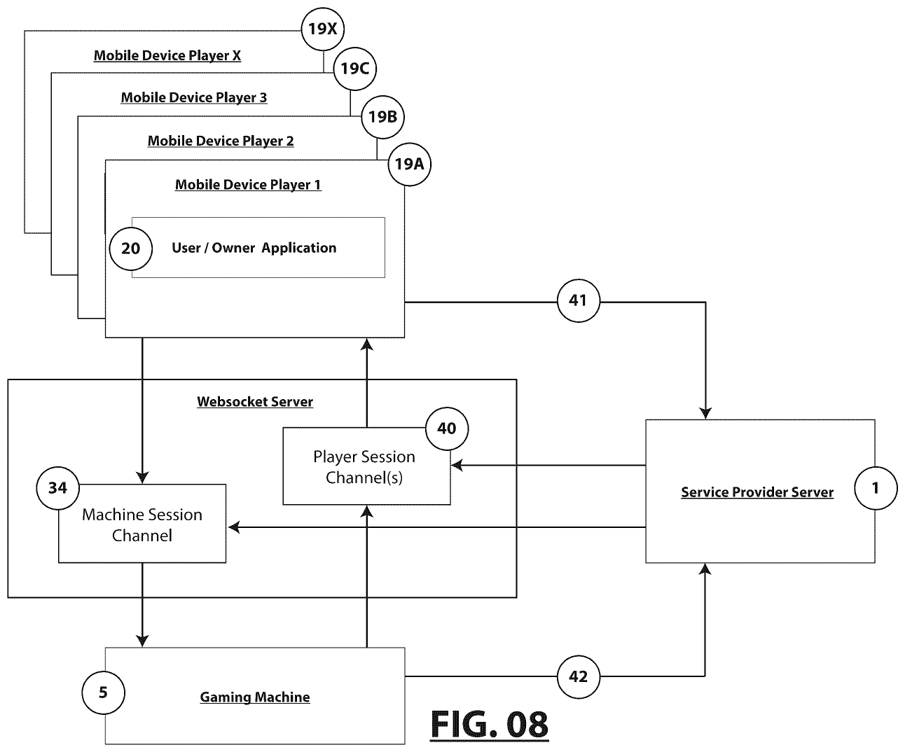

As seen in FIGS. 1 and 8, some features of the User Application and Owner Application [20] require secure real-time communication channels to be established between: 1) the gaming machine [5] and service provider server [1], 2) the User and/or Owner Application [20] and the service provider server [1], and 3) the gaming machine [5] and the User and/or Owner Application [20]. These communication channels are preferably established via authenticated private websocket connections to the websocket server [11]. While real-time communication via a websocket server is preferred, any form of communication to the service provider server is permissible.

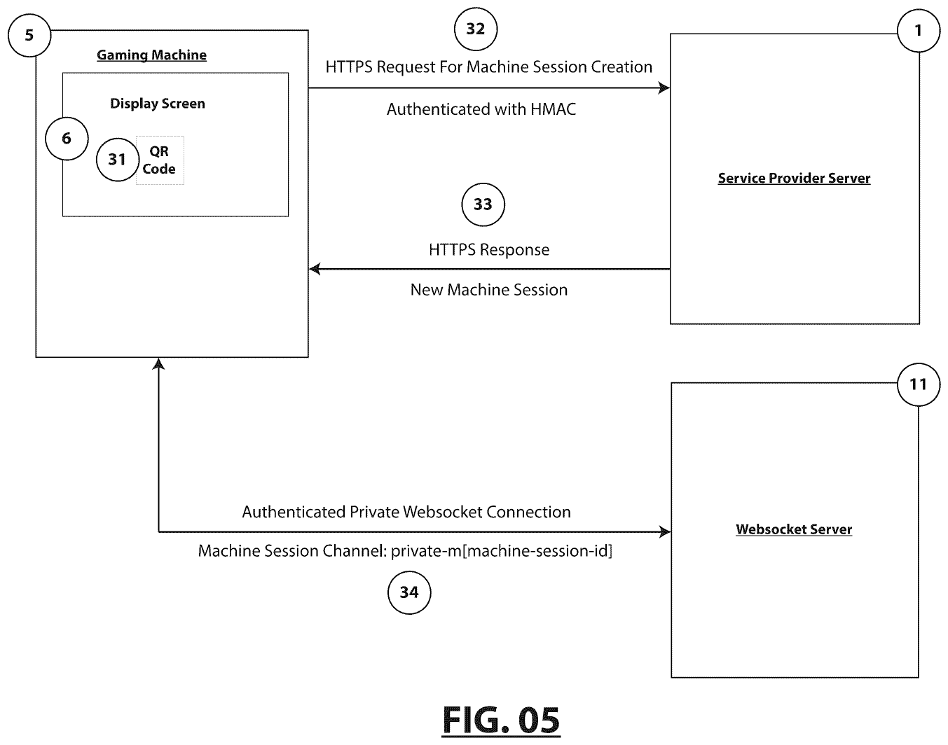

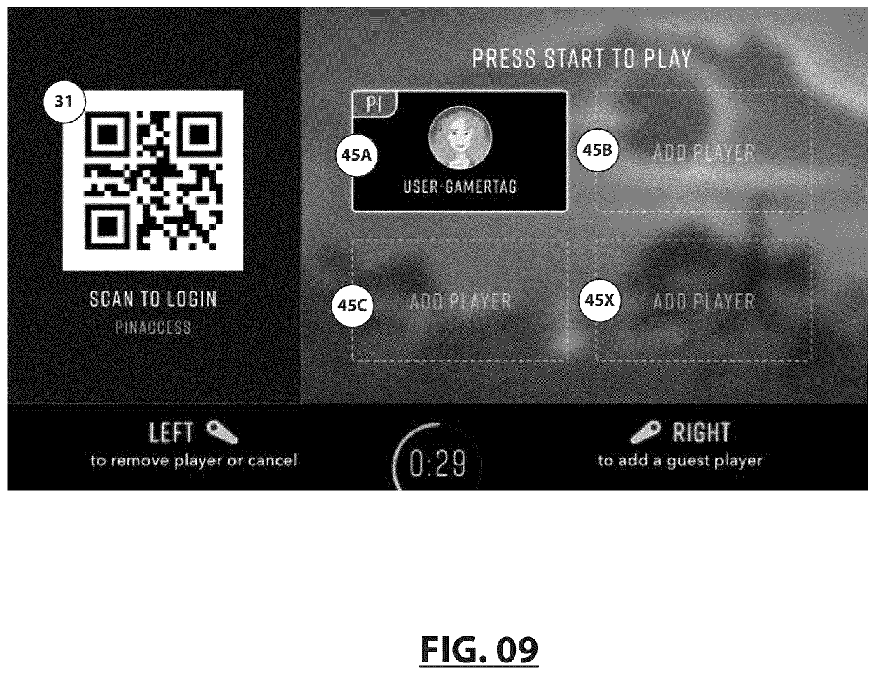

As seen in FIGS. 5 and 9, when a secure communication channel needs to be established between a gaming machine [5] and the service provider server [1] the gaming machine [5] may make a request [32] for a “Machine Session.” In the preferred embodiment, the request [32] is authenticated using the HMAC based authentication previously described in FIG. 3. The Machine Session will contain a unique code, information about the machine which requested the creation (such as the UMID), any fee requirements of the gaming machine [5], the time the session was created, and any other relevant information. The Machine Session request [32] may be generated upon a request from a user, may be initiated at a specific time on a routine schedule, or may be initiated upon start-up or power-up of the gaming machine [5]. Any information related to the Machine Session is stored on the service provider server [1].

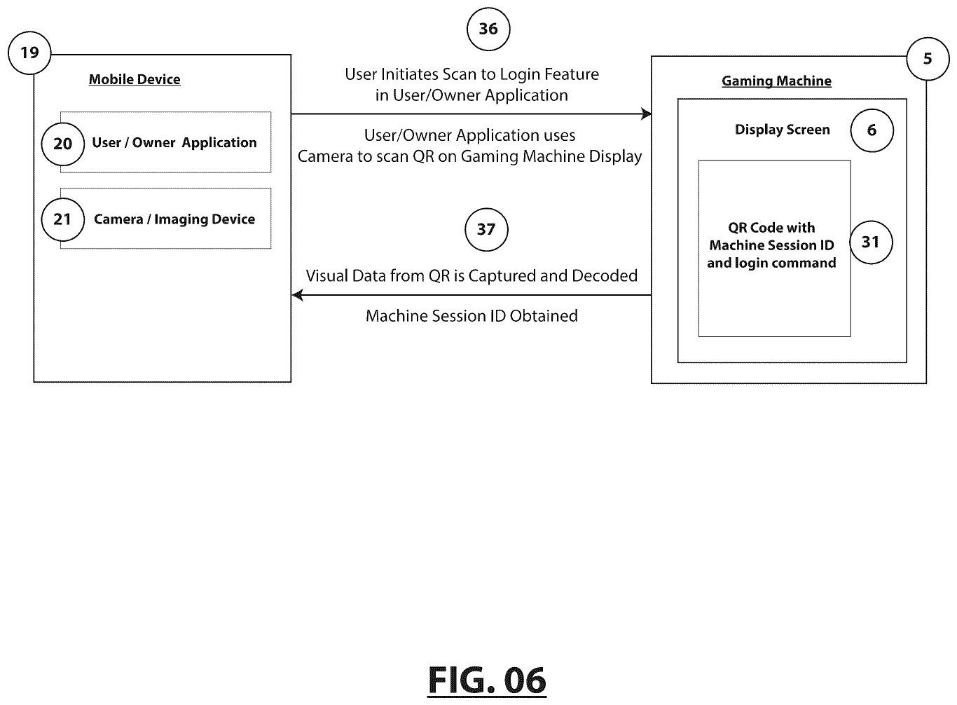

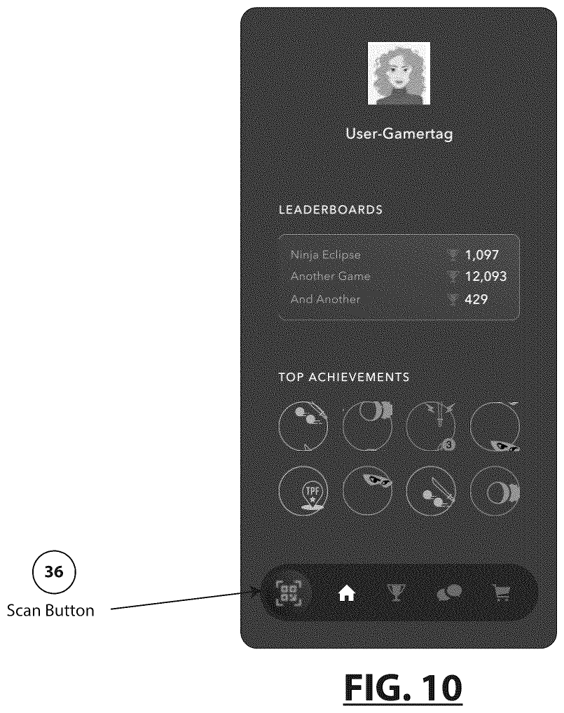

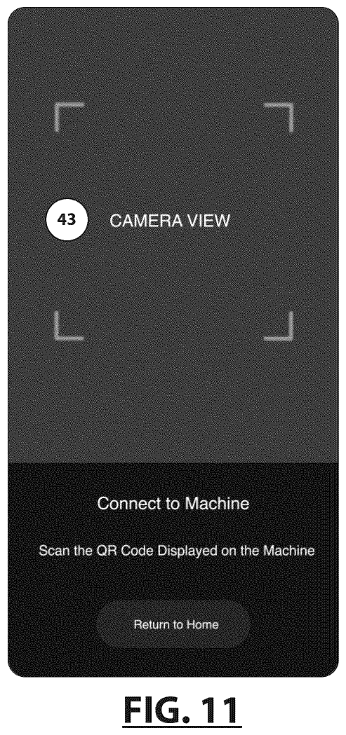

Once the gaming machine [5] receives a response [33] from the service provider server [1] in response to the Machine Session request, it may display a QR code [31] on the display screen [6] that contains embedded data representing the Machine Session code along with other relevant information. Generally, at the same time, or before displaying the QR code [31], the gaming machine [5] must also establish a secure real-time communication channel [34], referred to as the “Machine Session Channel” [34], with the service provider server [1] specifically for the newly created Machine Session. This is preferably accomplished via an authenticated private websocket connection [34] to the websocket server [11]. While real-time communication via a websocket server [11] is preferred, any form of communication to the service provider server [1] is permissible. Once the Machine Session Channel [34] is established, the gaming machine [5] can receive and react to real-time messages from the service provider server [1] that are sent on the Machine Session Channel [34]. As seen in FIGS. 6, and 10-11, when a QR code [31] is displayed on the display screen [6] of the gaming machine [5], a user may then open the User Application [20] on their mobile device [19] and use the scan feature [36] to initialize the camera view [43], which utilizes the imaging device [21] contained within the mobile device [19], and scan the QR code [31].

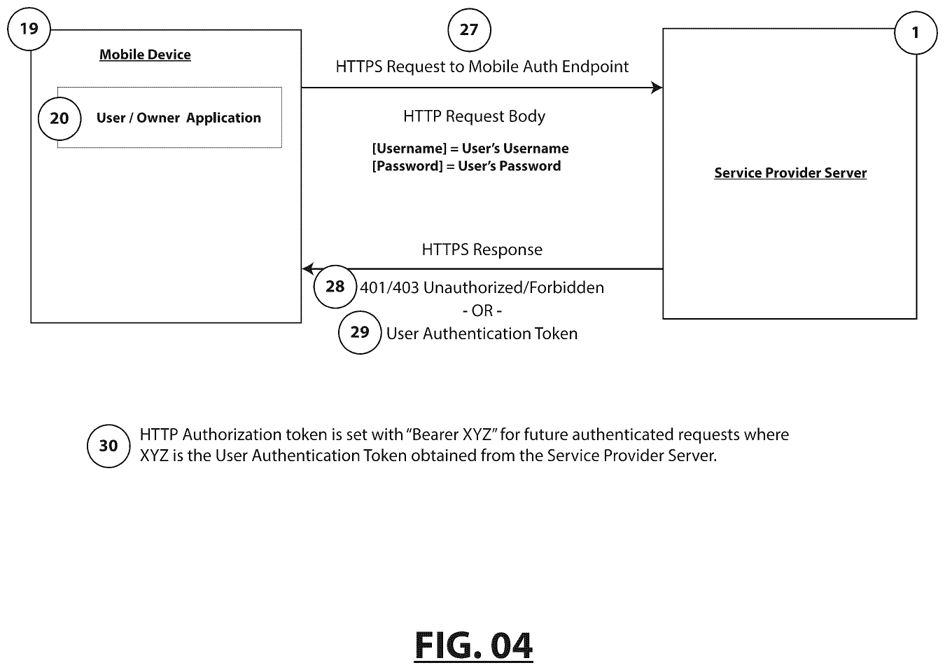

As seen in FIG. 4, prior to scanning a code or performing other account related features, the user must successfully authenticate to the service provider server via such means as a login request [27] made in the User Application [20] and processed by the web API of the service provider server [1]. If authentication does not match, the login request [27] is rejected by the service provider server [1], ensuring that no tampered or unauthorized login requests [27] are processed. Upon successful authentication with the service provider server [1], an authentication token [29] is returned to and stored on the mobile device [19] which can be used to make future authenticated requests [30] to the service provider server [1]. Such authentication token may be time sensitive or time restrictive for additional security.

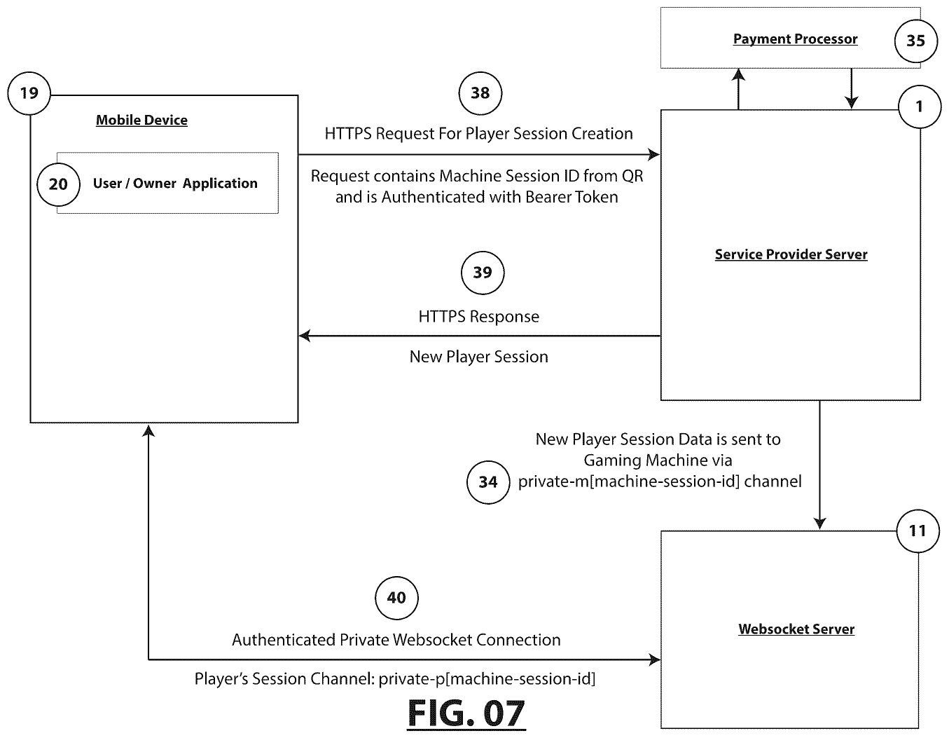

As seen in FIGS. 6-7, once a user is authenticated to the User Application [20] and scans a QR code [31] containing machine session information, the User Application [20] will decode the QR [31] to obtain the machine session code and any other relevant data. The User Application [20] will then make a secure authenticated request [38] to the service provider server [1] to create a “Player Session”, which is sent back in response [39]. Player Sessions are linked to the gaming machine and Machine Session which are created and stored in the service provider server [1]. The Player Session also stores data relevant to the game for that Player Session. This could include user score, achievements, fees paid for the session, or any other user and game related data. In addition to creating a Player Session, the User Application will also establish a secure real-time communication “Player Session Channel” [40] related to the Machine Session and the newly created Player Session. This is preferably accomplished via an authenticated private websocket connection to the websocket server [11]. While real-time communication is preferred, any form of communication to the service provider server [1] is permissible. This will allow the User Application [20] to receive and react to real-time messages sent by the gaming machine [5].

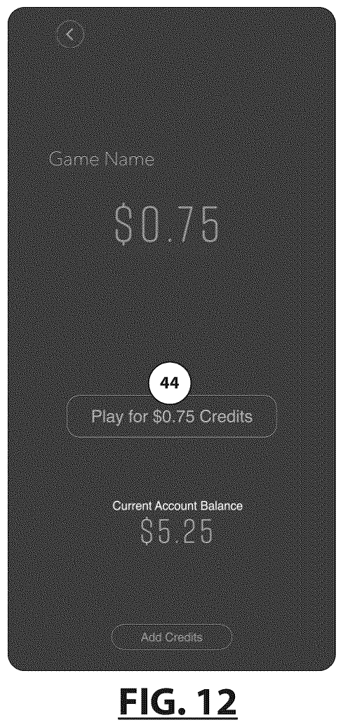

As seen in FIG. 12, when the user requests a Player Session by scanning a QR with the User Application [20], they may be prompted to provide payment [44] (if the machine is not configured for free play). The required fee information is provided to the User Application [20] as part of the Machine Session which was requested after scanning [36,43] the QR code [31] displayed on the gaming machine [5].

When a user creates an account, via the User Application [20] or service provider server's [1] website, they may enter and store their payment information as part of their account. This payment information may include credit cards, bank accounts, cryptocurrency, or any other form of payment. These payment methods may later be used when paying for fees required by gaming machines [5] in order to play. Fees may be charged directly at the time of payment by having the service provider server [1] communicate with a payment processor [35], as seen in FIG. 1, or the fee can be deducted from a stored balance (like a pre-purchased gift card) which was previously purchased and/or credited.

If a fee is required, as specified by a Machine Session, the user must successfully make the payment before receiving a Player Session response [39]. The transfer of that payment to the vendor/owner of the machine which required the payment is then facilitated by the service provider server [1] with information provided via the owner.

Whether a fee was required or not, once the Player Session is created by the service provider server [1], the gaming machine [5] is notified about the Player Session via the Machine Session Channel [34] that was previously established. Upon receiving the Player Session information, the gaming machine [5] can react by logging the user in and displaying any associated user data [45A] as seen in FIG. 9. This process can then repeat for subsequent users [45B-X], if desired, prior to the game starting.

As best seen in FIG. 8, once the game starts, the gaming machine [5] will have an open communication channel for the associated Machine Session, the Machine Session Channel [34], along with all of the data for all the Player Sessions that were created and linked to the Machine Session. The gaming machine [5] may then communicate with the users' mobile devices by sending data to the Player Session Channel [40] (or channels) associated with the Player Sessions that were created for the users. This can be done by sending data directly to those channels or by making requests [42] to the service provider server [1] which then are relayed to the Player Session Channels [40] by the service provider server [1]. The gaming machine [5], via programing, may differentiate between the type of data sent to the service provider server [1] and the Player Session Channel [40]. For example, data that is typically logged or saved, such as final scores or other achievements, is sent to the service provider server [1] so that it may be saved and associated with the user. However, other data, such as real time score updates, may be sent directly to the Player Session Channel [40] as this information does not need to be saved. Generally, data sent directly to the Player Session Channel [40] is intended for real time data in which a lag in delivery is undesirable. It also provides the benefit of limiting the data sent to the service provider server [1] to prevent lag and overloading the system.

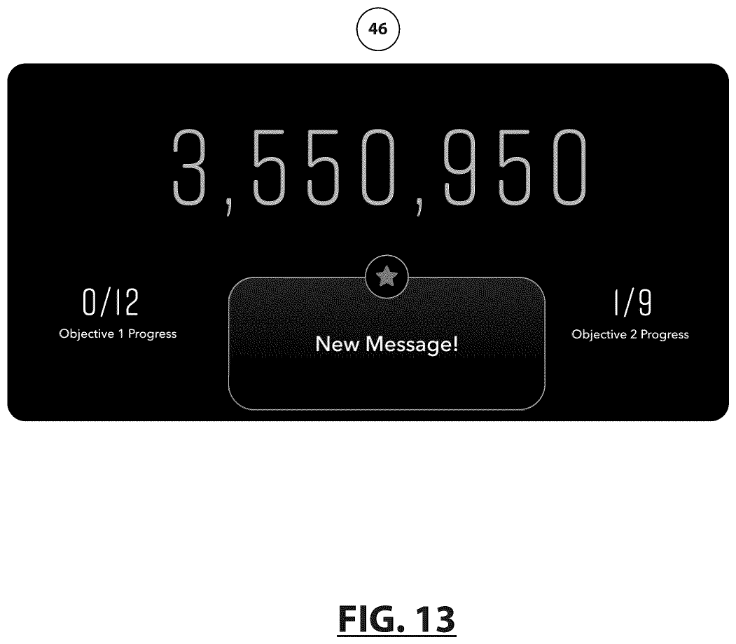

As seen in FIGS. 8 and 13, data sent to the users' mobile devices [19A-X] for use by the User Application [20] may include score, achievements, game tips, and any other game related data. This is desirable because it will allow a user to place their mobile device [19] in front of them on the glass of the gaming machine [5] and have a real-time view of their relevant game data [46] down by the flippers as their eyes track the ball in that area, instead of having to look up at the display screen [6] on the gaming machine [5].

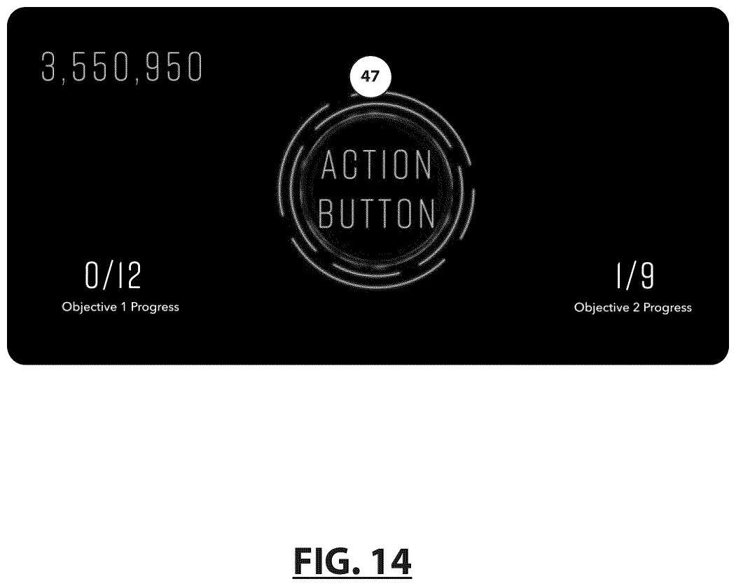

As seen in FIG. 8, it is also possible for the users' mobile devices [19-X] to communicate back to the gaming machine [5] via the Machine Session Channel [34]. This may be done by sending messages directly to the channel or by making requests [41] to the service provider server [1] which are relayed to the Machine Session Channel [40]. This communication allows interaction between the User Application [20] and the active game on the gaming machine [5]. One example of such interaction, as seen in FIG. 14, would be a menu of options, or a time sensitive action [47], sent by the gaming machine [5] to the Player Session Channel [40], displayed within the User Application [20], chosen by the user within the User Application [20], and sent back to the gaming machine [5] via the Machine Session Channel [34]. This is just one example, but any interaction desired between the user and the gaming machine [5] can be accomplished in this manner.

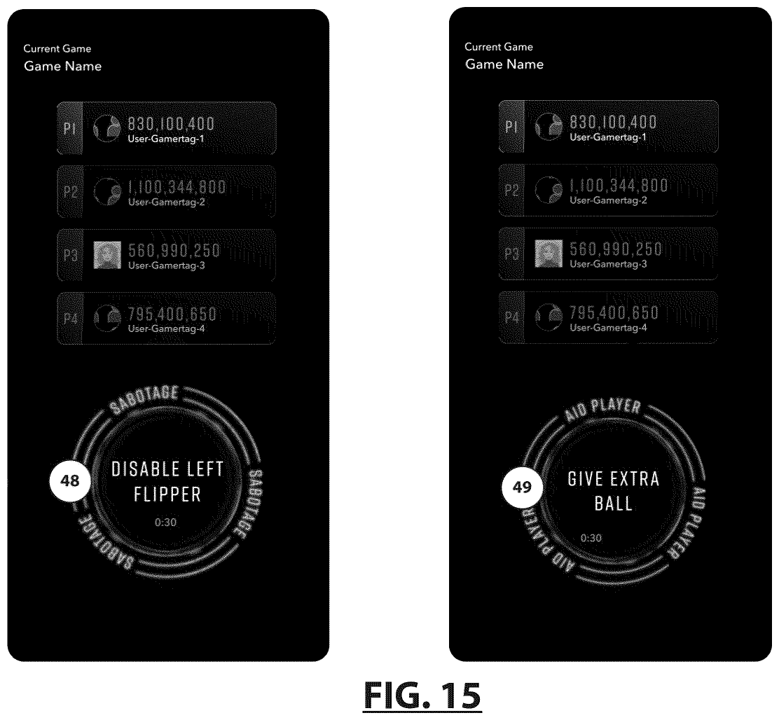

Additionally, in multi-user games as seen in FIGS. 8 and 15, it would be possible for users to interact with and influence the games of other users within the same Machine Session. For example, user 1 could earn a special achievement that allowed them to sabotage user 2 by weakening the flippers during gameplay. So, when user 2 is playing on the gaming machine, user 1 could click a button [48] within the live game view in their User Application [20] to perform the desired action. This interaction is permitted because of the authenticated communication channels established by the gaming machine [5] and the User Application [20] on the users' mobile devices [19A-X], which can all interact with one another. In team games, it may be desirable for user 1 to provide aid to a teammate. In such a case, they may be presented with an action button [49] allowing them to give an extra ball, or some other aid, to their teammate. In another feature, it may be possible to video stream one user's Player Session to another user's mobile devices [19A-X]through the User Application [20].

The service provider server [1] may include additional functionality like interactive communications between other users and/or owners, social networks, shops for merchandise, and organization of tournaments across multiple locations.

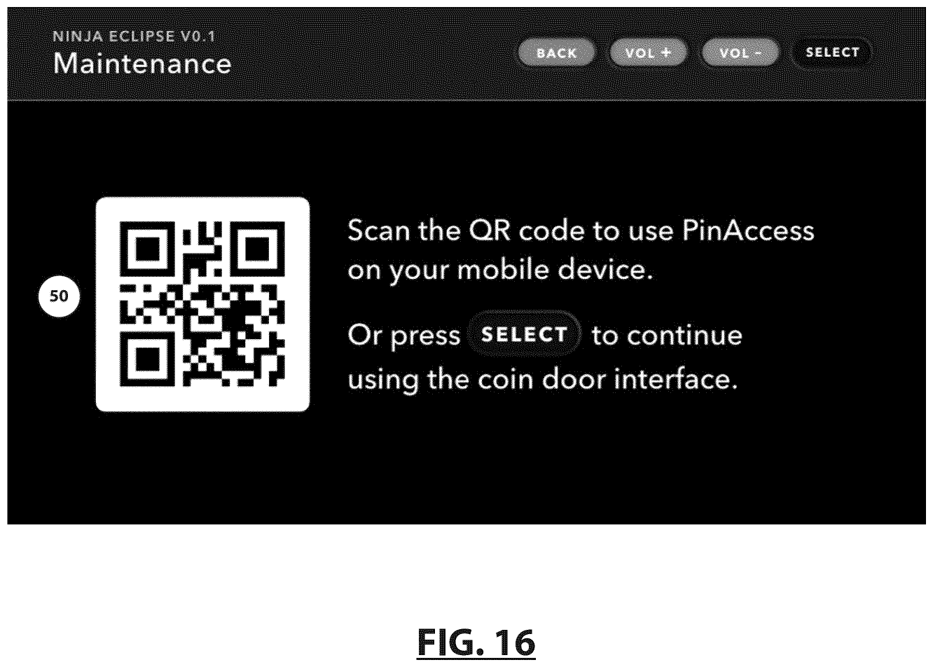

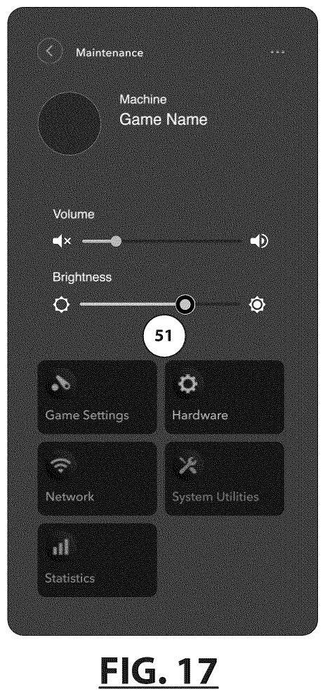

As seen in FIGS. 16 and 17, QR codes are also used in other areas such as for the servicing of the gaming machine [5]. Service mode allows the owner of the machine to configure settings, run diagnostics, view logs, and perform other relevant service operations through the Owner Application [20]. In the case of servicing the gaming machine [5], it may be undesirable to require an internet connection. Therefore, service mode may be performed via a Bluetooth connection [12] between a mobile device [19] and the machine [5]. This could also be performed via an internet connection [14] or any other electronic communication mechanism.

Because service mode should be restricted to the owner of the machine [5], or an authorized manager as identified by the owner, it is generally enabled via the use of a physical key. Other means of authentication, such as usernames/passwords, RFID cards, or similar methods, can also be employed. Once the owner has enabled service mode via some form of electronic or physical authentication, a QR code for service mode is displayed [50] on the screen of the gaming machine [5]. This is different from the QR code for Machine/Player Sessions [31] in that it contains information related to service mode instead. In the case of a Bluetooth connection [12], the QR code [50] provides the necessary information for the mobile device [19] to successfully establish a Bluetooth connection with the computing device [7] of the gaming machine [5]. Once connected to the machine [5], the Owner Application [20] can display a service menu [51] and send and receive service-related requests. Besides using a QR code for service mode, a more direct approach could be taken where the Owner Application [20] automatically detects and responds to an available machine service connection. However, for the sake of consistency in workflow, the scanning of a QR code to perform the action is preferred. In other embodiments, the owner may access their gaming machine's [5] information via the web after signing into the owner's account through the web interface of the service provider server [1]. The gaming machine [5] may also initiate a service mode request if the gaming machine [5] detects an anomaly during operation or determines servicing is needed. In such instances, the gaming machine [5] will communicate with service provider server [1] which will in turn notify the owner through the Owner Application [20], via email or other electronic messaging, or through logging into the web interface.

As seen in FIG. 2, for machines not initially designed with the System in mind, a retrofit device [60] will be available. The retrofit device [60] will enable secure electronic payments via QR codes and will be powered [61] by the legacy gaming machine or an alternative source. The retrofit device [60] includes an internet connected component [62] and an electronic relay or equivalent circuit [64], both connected by a microcontroller or similar [63]. The retrofit device [60] is embedded in the legacy gaming machine [15] and connected to one or more switches [66] in the coin door which notify the legacy gaming machine [15], through existing machine circuitry [65], when coins or money is inserted. When activated, the retrofit device [60] closes the switch [66] via the relay [64] which will make the legacy gaming machine [15] act as if a coin was inserted.

The retrofit device [60] may or may not have a display screen [17] of its own and may have an interface [18] with the legacy gaming machine [15]. The retrofit device has a unique ID, PSK, and the public key of the service provider server [1]. If it has a display screen [17], it can request Machine Sessions and generate QR codes like a normal gaming machine [5] which was designed to work with the System. If it doesn't have a screen, a static QR code sticker could be used in its place. The sticker would be affixed to the legacy gaming machine [15] in an obvious location along with instructions for use. In either case, the device will request and maintain a secure communication channel, via the websocket server [11] or another real-time communication mechanism, where it can receive messages from the service provider server [1]. Upon scanning either version of the QR with the User Application [20] on an authenticated mobile device [19], the service provider server [1] would then send a message to the embedded retrofit device [60] over the secure communication channel to tell it to activate the relay [64] to simulate the insertion of a coin. Although it isn't required, it is desirable for a response to be sent to the service provider server [1] from the embedded retrofit device [60] to confirm receipt of the payment message. That ensures that the message was not lost and that the user's payment account is not debited for unsuccessful transactions.

A more tightly coupled retrofit device [60] may also be used to provide additional functionality besides insertion of coins. This device would require additional connections to the computer circuitry of the machine in which it is embedded. This would allow data, such a score, to be sent from the retrofitted machine to the service provider server [1] to be linked to the user's profile.

It is also possible that a machine may be retrofitted by modifying the actual software running on the machine, which could allow the machine to operate as a gaming machine [5] with the System installed, without the need of the retrofit device [60].

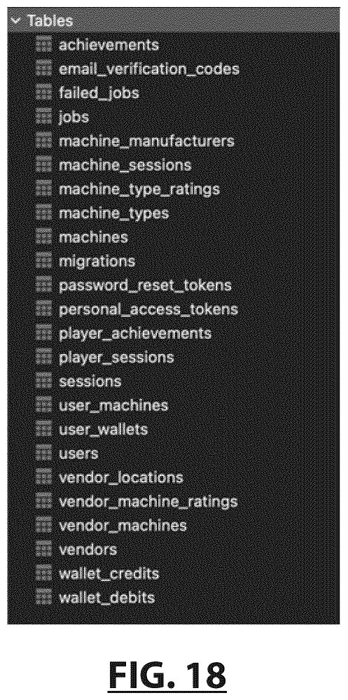

As seen in FIG. 18, the table identifies an exemplar of information that may be saved in the database [2] of the service provider server [1].

The description of the present invention has been presented for purposes of illustration and description and is not intended to be exhaustive or limiting to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

1. I claim an authentication and network system for gaming machines comprising a
Service provider server having a
First set of instructions capable of storing information comprising a first machine ID:
A second set of instructions capable of receiving a machine session request from a gaming machine comprising a second machine ID;
A third set of instruction capable of authorizing the machine session request if the first machine ID matches the second machine ID, generating a first machine session code, and transmitting the first machine session code to the gaming machine;
A fourth set of instructions capable of receiving a player session request from a user application comprising the user ID and a second machine session code; and
A fifth set of instructions authorizing the player session request if the first machine session code matches the second machine session code.
